(19) United States
(12) Patent Application Publication
(10) Pub. No.: US 2012/0224733 A1
(43) Pub. Date: Sep. 6, 2012

(54) FITTING OF SOUND PROCESSORS USING IMPROVED SOUNDS

(76) Inventor: Peter John Blamey, South Yarra (AU)

(21) Appl. No.: 13/388,268

(22) PCT Filed: Aug. 2, 2010
(86) PCT No.: PCT/AU2010/000969

§ 371 Date: Apr. 5, 2012

(30) Foreign Application Priority Data
Aug. 2, 2009 (AU) 2009903590

(51) Int. Cl. H04R 25/00

(52) U.S. Cl. 381/320

(57) ABSTRACT

In one embodiment, a method for customising a sound processing device for an individual listener including presentation of one or more sounds to the listener directly from the sound processing device, each sound comprising a collection of two or more harmonically related tones, spectrally positioned about a frequency of interest, and having a temporal envelope consisting of a rise time, sustain time, and decay time, obtaining information from the listener, adjusting the level of the sounds, and using the adjusted levels to set up the sound processing device for the listener.

### FIELD OF THE INVENTION

The present invention relates to the fitting of hearing aids and assistive listening devices (ALDs) to users without an audiogram to enhance the hearing of sound by the user. The Global Medical Device Nomenclature Agency (GMDNS) definition of an ALD is an amplifying device, other than a hearing aid, for use by a hard of hearing person.

### BACKGROUND OF THE INVENTION

Sound processors, including hearing aids, ALDs, and consumer audio devices such as headsets, headphones, mobile phone handsets, and MP3 players are being used more frequently in noisy environments by people with normal or near-normal hearing as well as people who are hard of hearing. Under these circumstances, hearing can be enhanced by adjusting the loudness, frequency-shaping, and dynamic properties of the sounds produced by the devices to suit the needs and preferences of the individual listener. In the case of hearing aids, these services are typically provided by audiologists and/or audiometrists in a clinical setting. Some of these types of adjustments are commonly available in consumer audio devices by means of analogue volume controls and tone controls.

The majority of these devices now use digital signal processing which enables a much wider variety of adjustments and customisations to suit the individual needs and preferences of users. At the same time, devices are becoming smaller and do not have the physical space available for the complex controls that would be necessary to make a wide variety of adjustments. One way to make adjustments is to use an applications program running on a computer and download the customised solution to the device to be used in stand-alone operation. This is typical for hearing aids, but not for ALDs and consumer audio devices that tend to use analog volume and tone controls. The fitting software for modern hearing aids may manipulate tens or even hundreds of parameters that control the operation of the hearing aid, and are downloaded to the device after fitting is complete. The adjustment typically requires a skilled audiologist, audiometrist, or hearing aid fitter. Digital sound processing for other consumer audio devices can also be configured by software running on a computer and subsequently downloaded to the device. This configuration is typically made by the manufacturer prior to sale of the device and tailors the device to the needs of the average user, rather than customising it for an individual. Sometimes an individual may choose from a number of preconfigured customizations (for example in the case of an ALD).

The sound processing device fitting methods described above suffer from the disadvantage that either a skilled fitter is required to operate the fitting software (as in the case of a hearing aid), or a single ‘average’ fitting or small number of preconfigured customizations is too limited to be well suited to each individual.

Furthermore, conventional hearing aid fitting methods require specialised equipment such as an audiometer to measure hearing thresholds and other hearing characteristics, and hearing aid test boxes to measure and set the hearing aid gain and/or output using a hearing aid prescription based on the audiogram. The sounds used for measurements of hearing and hearing aid gain are usually pure tones, narrow-band noises, or other synthetic sounds such as speech-shaped noise or broadband harmonic complexes. These sounds do not occur in natural contexts and are often unfamiliar and unpleasant for people to listen to. The listener may find it difficult to perform tasks such as setting the sounds to a comfortable level because the sounds themselves have unpleasant or “uncomfortable” characteristics no matter how loud or soft they may be.

Any discussion of documents, acts, materials, devices, articles or the like which has been included in the present specification is solely for the purpose of providing a context for the present invention. It is not to be taken as an admission that any or all of these matters form part of the prior art base or were common knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY OF THE INVENTION

The present invention is a simplified method of fitting a hearing aid or other audio device that uses sounds that will sound pleasant to the listener during the fitting process. In the following, the sounds are sometimes described as “musical notes” or “notes” where each note is comprised of two or more tones with frequencies that are harmonics of a fundamental frequency and having a common amplitude envelope characterised by a rise time, a sustained section, and a relatively long decaying fall in amplitude. Each note is a recorded or synthesized sound with well-controlled amplitude and frequency characteristics in order to provide precise frequency-specific measures of hearing. The invention comprises: a method and apparatus to present notes to the listener for the purpose of measuring hearing characteristics and preferences; and a method and apparatus for customizing the device using the measured hearing characteristics. The notes are presented to the listener acoustically directly from the sound processing device. They may be recorded or generated and fed electrically via a direct input to the sound processing device, or may be generated or stored within the sound processing device itself. The customisation method includes listening to one or more notes and adjusting their level in response to simple instructions such as “adjust the sound until it is comfortable” or “adjust the sounds until they are all equally loud”. After adjustment of the musical notes by the listener, the device is configured by a suitable automated protocol to optimize the sound quality for the listener.

According to a first aspect the present invention provides a method for customizing a sound processing device for an individual listener. The method comprises:

Presenting one or more notes via a sound processing device to a listener, each note comprising a collection of two or more harmonically related tones, spectrally positioned about the frequency of interest, and having a temporal envelope consisting of a rise time, sustain time, and decay time;

Obtaining the listener's input regarding the loudness of each delivered sound and adjusting the levels of the sounds; and

Inputting the adjusted levels of the sounds into an automated process to configure and tune the sound processing device for the listener.

According to a second aspect the present invention provides a system for customizing a sound processing device for an individual listener. The system comprises:

a computing device configured to control presentation of one or more notes to a listener, each note comprising a collection of two or more harmonically related tones, spectrally positioned about the frequency of interest, and having a temporal envelope consisting of a rise time, sustain time, and decay time, and including a visual display and user input device for the control of the customization process;

a sound processing device to output notes to the listener;

an optional programming interface device to connect the sound processing device to the computing device so that the sound processing device may be controlled by the computing device; and

a software program running on the computing device to control the presentation and adjustment of the level of the notes, and automatically configure the sound processing device based on the adjusted levels of the notes.

According to a third aspect, the present invention provides a computer program product for customizing a sound processing device for an individual listener. The computer program product comprises:

computer program code for presenting one or more notes via a sound processing device to a listener, each note comprising a collection of two or more harmonically related tones, spectrally positioned about the frequency of interest, and having a temporal envelope consisting of a rise time, sustain time, and decay time;

computer program code for obtaining the listener's input regarding the loudness of each delivered note and adjusting the levels of the notes; and

computer program code for inputing the adjusted levels of the notes into an automated process to configure and tune the sound processing device for the listener.

The computing device may be a personal computer, mobile phone handset or other suitable device.

The sound processing device may be a hearing aid, an assistive listening device, or a mobile phone handset.

The adjustment of levels may be to set each note to a comfortable level or to balance the loudness of a set of notes at different frequencies of interest so that they are equally loud.

In one preferred embodiment of the invention, simplified fitting software runs on a personal computer. The simplified fitting software controls the presentation of a sequence of musical notes to the listener and records the listener's responses to balance the loudness of the musical notes. The musical notes are generated by the sound processing device itself under the control of the fitting software. In some embodiments, the notes are generated by creating a square wave, filtering the square wave with a bandpass filter to select harmonics or tones only in a narrow frequency range, and modulating the amplitude of the selected harmonics with an amplitude envelope to create a sound similar to a musical note. The envelope in preferred embodiments may be fixed, or in other embodiments may be alterable. Notes with different frequency characteristics are created by changing the filter cut-off frequencies. The personal computer is connected to the sound processing device by a wired or wireless programmer interface. The simplified fitting software uses the listener's responses to configure and program the sound processing device to optimise its performance for the individual listener.

In a second preferred embodiment of the invention, the functions of the personal computer are performed by a mobile phone handset.

In a third embodiment of the invention, the mobile phone handset is the customizable device as well as being the computing device that executes the simplified fitting software.

In some embodiments, the tones comprising the musical note may be spaced apart in frequency by a fixed amount, regardless of the frequency of interest. Alternatively, the tones comprising the musical note may be spaced apart in frequency by an amount which varies with the frequency of interest, for example the spacing of the tones may be proportional to the frequency of the tones.

In some embodiments, the tones comprising the musical note may be generated directly instead of being derived from a filtered square wave as described above.

The advantages of some embodiments of the present invention may include: The use of natural sounding musical notes for the characterisation of hearing instead of pure tones and noises that sound unnatural and unpleasant to some people, thus improving the validity of the hearing measurements; The presentation of notes directly through the sound processing device so that no compensation is required for individual acoustic differences between devices or between listeners; Rapid and convenient access to well-fitted hearing aids for users in remote locations or in countries where audiology services are rudimentary or non-existent; Rapid and convenient access to well-fitted sound processing devices of all types for users with normal or impaired hearing without the need for specialised equipment or skilled operators; An effective method of individual customization of sound processing devices requiring complex adjustments without increasing the size and complexity of the devices themselves; and a method to allow users to refine the customization of sound processing devices for themselves.

The simplified fitting method may be used as part of an online audiology system such as of the type disclosed in PCT/AU2010/000161, the contents of which are incorporated herein by reference, in a conventional audiology practice, in a retail environment, or in an online consumer environment.

The enhancement provided by the invention may be an improvement in speech intelligibility, sound quality, comfort and naturalness of the amplified or processed sound in quiet and/or noisy environments.

### BRIEF DESCRIPTION OF THE DRAWINGS

FIG. 1 illustrates the amplitude envelope of a musical note generated by the computer, mobile phone handset or the sound processing device.

FIG. 2 illustrates a preferred filter shape with low frequency cutoff 201 and high frequency cutoff 202, which are used to set the frequency characteristics of the filter including its bandwidth 203.

FIG. 3 illustrates a square wave waveform used to generate harmonics from which 2 or more tones may be selected to generate a musical sound. The square wave is characterised by its period 301 and its amplitude 302.

FIG. 4 illustrates the spectrum of a musical note comprising a collection of three harmonically related tones, spectrally positioned about the frequency of interest. The collection of tones is characterised by the number of tones and the frequency of each tone, or equivalently the frequency of interest and the frequency spacing of the tones.

FIG. 5 illustrates one preferred embodiment of the fitting system, showing its components.

FIG. 6 illustrates a second preferred embodiment of the fitting system showing its components.

### DESCRIPTION OF THE PREFERRED EMBODIMENTS

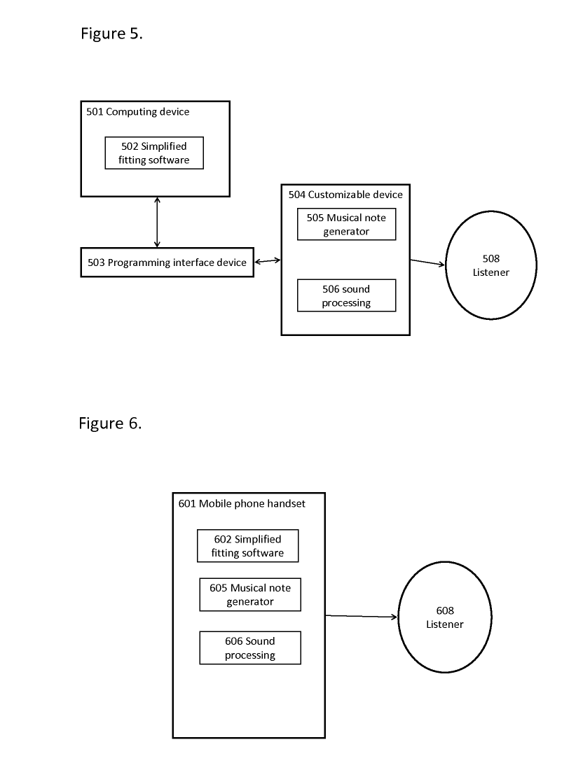

FIG. 5 illustrates an example architecture for one preferred embodiment of the simplified fitting system, showing its components. The personal computer 501 runs the simplified fitting software 502. The function of the fitting software 502 is to control the generation and presentation of the musical notes, accept responses from the listener 508, and automatically create a customised fitting for the sound processing device 504, and download it to the device 504. The personal computer 501 communicates with the sound processing device 504 via the programming interface 503. The musical notes are generated 505 within the sound processing device 504. The resultant note is converted to an acoustic signal and presented to the listener 508 under the control of the fitting software 502.

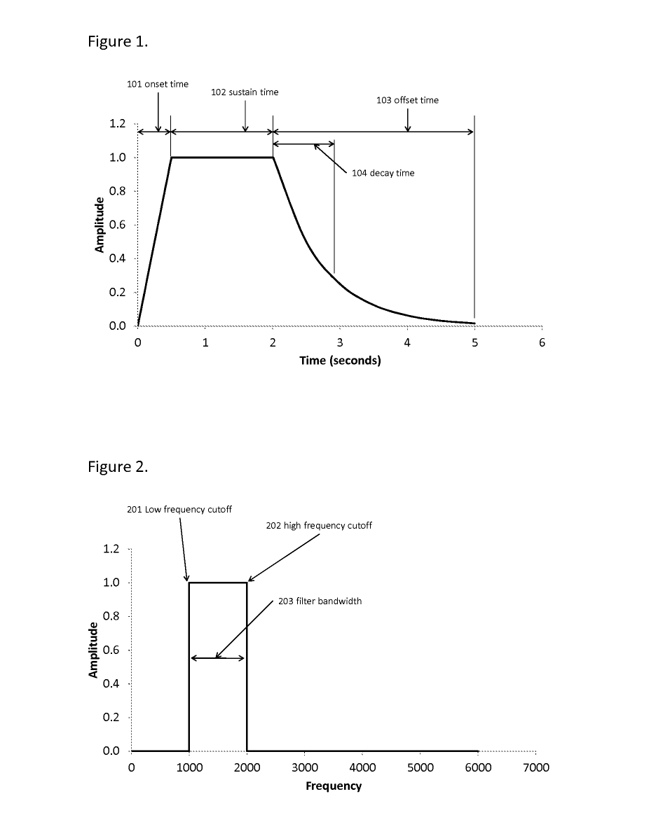

FIG. 1 illustrates an exemplary amplitude envelope of a musical note 505 generated by the sound processing device 504. The amplitude envelope is determined by the onset time 101, the sustain time 102, the offset time 103 and the decay time 104. The parameters help to determine the loudness and timbre of the sound. Typical onset times 101 are in the range 10 to 100 ms, and preferably in the range 25 to 60 ms; Typical sustain times 102 are in the range 0 to 1000 ms, and preferably in the range 200 to 500 ms; and typical offset times 103 are in the range 50 to 1500 ms, and preferably in the range 300 to 1000 ms. The decay time 104 is the time for the sound to decay exponentially to 1/e of its maximum level. The decay time 104 is typically 50 to 2000 ms, and preferably in the range 100 to 700 ms.

FIG. 2 illustrates an exemplary filter shape with low frequency cutoff 201 and high frequency cutoff 202, which are used to set the frequency characteristics of the filter including its bandwidth 203. In a preferred embodiment, the filter cut-off frequencies are varied to create filters centred around the audiological frequencies of interest 250, 500, 1000, 1500, 2000, 3000, 4000, 6000 Hz, and with bandwidths in the range ⅙ to 1 octave, and preferably in the range ¼ to ½ octave. More or fewer frequencies of interest may be chosen, as may other values.

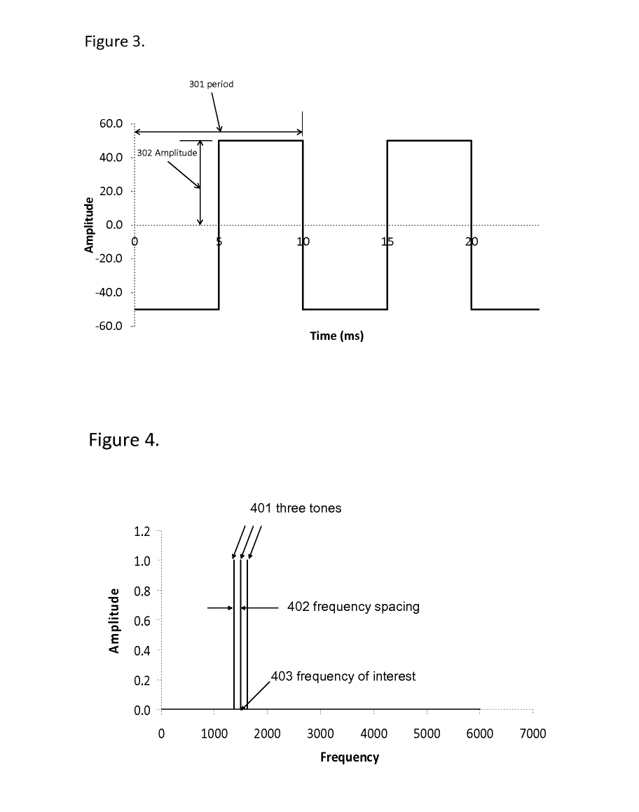

FIG. 3 illustrates a square wave waveform used to generate a musical sound. The square wave is characterised by its period 301 and its amplitude 302. Typically, the frequency of the square wave would be 50 to 500 Hz, to provide harmonics spacing at 50 to 500 Hz intervals. Preferably, the frequency spacing of the harmonics is in the range 100 to 300 Hz. The amplitude of the musical notes is easily controlled by changing the amplitude 302 of the square wave.

FIG. 4 illustrates an exemplar spectrum of a musical note consisting of three tones 401 centred about a frequency of interest 403 at 1500 Hz and spaced at 125 Hz 402. The number of tones 401 may be in the range 2 to 10, preferable in the range 3 to 5. In a preferred embodiment, the frequencies of interest 403 are the audiological frequencies 250, 500, 1000, 1500, 2000, 3000, 4000, 6000 Hz. More or fewer frequencies of interest 403 may be chosen, as may other values. The spacing of frequencies 402 may be in the range 50 to 500 Hz, preferably in the range 100 to 300 Hz. In a preferred embodiment, the frequency spacing 402 is 125 Hz for frequencies of interest 401 up to 1000 Hz and 250 Hz for frequencies of interest above 1000 Hz. The amplitude of the tones may be equal or unequal.

One preferred embodiment is shown in FIG. 5. The simplified fitting software 502, running on the computing device 501 controls the output of musical notes from the sound processing device 504 by sending control parameters including the number 401, frequencies, and amplitudes of the tones making up the notes via the programming interface 503 to the sound processing device 504. The listener 508 hears a sequence of musical notes of differing frequency and is instructed to adjust the loudness of the individual notes until they are equal and comfortable in loudness. Once the musical notes have been balanced in loudness, the simplified fitting software calculates a customised fitting for the sound processing device 504 using the balanced note levels to determine the frequency response and other parameters of the fitting. The customised fitting is loaded and saved into the sound processing device 504 via the programming interface 503.

In alternative embodiments of the invention, the musical notes are generated in the personal computer 501 and transmitted electrically from the computer 501 to the sound processing device 504.

In a second preferred embodiment of the invention the functions of the computing device 501 are performed by a mobile phone handset. In this embodiment no programming interface device 503 is needed.

In a third preferred embodiment of the invention shown in FIG. 6, a mobile phone handset is the customizable sound processing device 601 as well as the computing device 601 that runs the simplified fitting software 602. In this case, the musical notes are generated in the mobile phone handset 605, and the frequency response and other characteristics of the phone output are optimised for the listener by using the loudness balanced output levels of the musical notes.

Some portions of this detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent series of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, codes, or the like.

As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data are maintained are physical locations of the memory that have particular properties defined by the format of the data. However, while the invention is described in the foregoing context, it is not meant to be limiting as those of skill in the art will appreciate that various of the acts and operations described may also be implemented in hardware.

It should be borne in mind, however, that all of these and similar terms are to be associated with the appropriate physical quantities and are merely convenient labels applied to these quantities. Unless specifically stated otherwise as apparent from the description, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive.

1. A method for customizing a sound processing device for an individual listener, the method executed by a computing device and comprising:
presenting one or more notes via the sound processing device to the listener, each note comprising a collection of two or more harmonically related tones, spectrally positioned about a frequency of interest, and having a temporal envelope consisting of a rise time, sustain time, and decay time;
obtaining the listener's input regarding the perceived loudness of each delivered note, and adjusting the levels of the notes; and
inputting the adjusted levels of the notes into an automated process to configure and tune the sound processing device for the listener.

2. (canceled)

3. The method of claim 1 wherein the frequency spacing of the harmonically related tones is in the range 100 to 300 Hz.

4. (canceled)

5. The method of claim 1 wherein the rise time of the note is in the range 25 to 60 ms.

6. (canceled)

7. The method of claim 1 wherein the sustain time of the note is in the range 200 to 500 ms.

8. (canceled)

9. The method of claim 1 wherein the decay time of the note is in the range 100 to 700 ms.

10. The method of claim 1 wherein the adjustment of the level of the notes is to make the note comfortable.

11. The method of claim 1 wherein the adjustment of the level of the notes is to make each note equal in perceived loudness to every other note.

12. (canceled)

13. A system for customizing a sound processing device for an individual listener, the system comprising:
a computing device configured to control presentation of one or more notes to a listener, each note comprising a collection of two or more harmonically related tones spectrally positioned about the frequency of interest, and having a temporal envelope consisting of a rise time, sustain time, and decay time, and including a user input for the control of the customization process;
a sound processing device to output notes to the listener;
means to connect the sound processing device to the computing device so that the sound processing device may be controlled by the computing device; and
the computing device further being configured to control the presentation and adjustment of the level of the notes, and automatically configure the sound processing device based on the adjusted levels of the notes.

14. (canceled)

15. The system of claim 13 wherein the frequency spacing of the harmonically related tones is in the range 100 to 300 Hz.

16. (canceled)

17. The system of claim 13 wherein the rise time of the note is in the range 25 to 60 ms.

18. (canceled)

19. The system of claim 13 wherein the sustain time of the note is in the range 200 to 500 ms.

20. (canceled)

21. The system of claim 13 wherein the decay time of the note is in the range 100 to 700 ms.

22. The system of claim 13 wherein the adjustment of the level of the notes is to make each note comfortable.

23. The system of claim 13 wherein the adjustment of the level of the notes is to make each note equal in perceived loudness to every other note.

24. (canceled)

25. A computer program product for customizing a sound processing device for an individual listener, the computer program product comprising:
computer program code for presenting one or more notes via the sound processing device to the listener, each note comprising a collection of two or more harmonically related tones, spectrally positioned about a frequency of interest, and having a temporal envelope consisting of a rise time, sustain time, and decay time;
computer program code for obtaining the listener's input regarding the perceived loudness of each delivered note and adjusting the levels of the notes; and
computer program code for inputting the adjusted levels of the notes into an automated process to configure and tune the sound processing device for the listener.

26. (canceled)

27. The computer program product of claim 25 wherein the frequency spacing of the harmonically related tones is in the range 100 to 300 Hz.

28. (canceled)

29. The computer program product of claim 25 wherein the rise time of the note is in the range 25 to 60 ms.

30. (canceled)

31. The computer program product of claim 25 wherein the sustain time of the note is in the range 200 to 500 ms.

32. (canceled)

33. The computer program product of claim 25 wherein the decay time of the note is in the range 100 to 700 ms.

34. The computer program product of claim 25 wherein the adjustment of the level of the notes is to make each note comfortable.

35. The computer program product of claim 25 wherein the adjustment of the level of the notes is to make each note equal in loudness to every other note.

36.-45. (canceled)
